(19) United States
(12) Patent Application Publication
(10) Pub. No.: US 2008/0025262 A1
(43) Pub. Date: Jan. 31, 2008

(54) Method for performing handoff from WiBro(WIMAX) service to wireless LAN service and terminal apparatus using the same title

(76) Inventors: Jeong Min Kim, Seoul (KR); Hyo Jin Choi, Seoul (KR); Jin Hwan Jeon, Seoul (KR); Dae Hong Kim, Seoul (KR); Kyeongho Lee, Seoul (KR); Sang Min Shim, Seoul (KR); Won Hoeh Song, Seoul (KR)

Correspondence Address: THE FLESHNER GROUP, PLLC, P.O. BOX 1397, ASHBURN, VA, 20146-9998, US

(21) Appl. No.: 11/878,937

(22) Filed: Jul. 27, 2007

(30) Foreign Application Priority Data
Jul. 28, 2006 (KR) 10-2006-0071223

(51) Int. Cl. H04Q 7/00

(52) U.S. Cl. 370/331

(57) ABSTRACT

Embodiments of systems (e.g., the terminal apparatus) and methods according to the application can perform a handoff from a WiBro (wireless broadband) service to a wireless LAN service or from a WIMAX (worldwide interoperability for microwave access) service to a wireless LAN service. One embodiment can perform a communication according to a WIMAX or WiBro standard and, upon entering into an area where a communication conforming to a wireless LAN standard is available, perform a communication according to the wireless LAN standard.

### FIELD OF THE INVENTION

The application relates to systems and methods for performing a communication according to a wireless standard (e.g., WIMAX or WiBro).

### BACKGROUND OF THE INVENTION

A WIMAX (worldwide interoperability for microwave access) or a WiBro (wireless broadband) service, i.e., a communication service for enabling a wireless internet connection during movement by using a portable terminal apparatus, are being used. Since both of the WIMAX and the WiBro service have analogous objects, they are simply referred to as the WiBro, hereafter. The WiBro is advantageous in that it supports portability (e.g., maximum 60 Km/h) and a handoff between base stations like a cellular phone, and also supports a higher transmission speed per subscriber (e.g., a maximum uplink transmission speed of 1 Mbps and a maximum downlink transmission speed of 3 Mbps) than a conventional cellular phone. Further, since the WiBro has a larger cell radius than a wireless LAN, it can provide a service covering a larger area.

However, as described above, the WiBro has various disadvantages. For example, the WiBro has a lower transmission speed than the wireless LAN.

### SUMMARY OF THE INVENTION

An object of embodiments of the application is to solve at least problems and/or disadvantages of the related art or to provide at least the advantages described herein in whole or in part.

Another object of the application is to provide a method for performing a handoff from a WiBro service to a wireless LAN service and a terminal apparatus using the method.

Another object of the application is to provide a method for providing a user with a service supporting a higher transmission speed and a terminal apparatus using the method by performing a handoff to a wireless LAN service upon entering into an area where a communication conforming to a wireless LAN standard is available.

Another object of the application is to provide a method for providing a user using a first service with a second service supporting a higher transmission speed and a terminal apparatus using the method by performing a handoff to a wireless LAN service upon entering into an area where a communication conforming to a wireless LAN standard is available.

Another object of the application is to provide a terminal apparatus that allows a wireless LAN baseband processor to share a RF circuit and an antenna with a WiBro baseband processor to reduce a manufacturing cost, and a method (e.g., handoff using the terminal apparatus.

Another object of the application is to provide a system for performing a handoff from a WiBro (wireless broadband) service to a wireless LAN service or from a WIMAX (worldwide interoperability for microwave access) service to a wireless LAN service and/or a terminal apparatus using the same, method for performing a communication according to a WiBro or WIMAX standard and, upon entering into an area where a communication conforming to a wireless LAN standard is available, performing a communication according to the wireless LAN standard and an apparatus using such a method.

To achieve objects of embodiments of the application in whole or in part, there is provided a handoff method that can include communicating with a WiBro or WIMAX base station by a terminal apparatus, informing the WiBro or WIMAX base station that the terminal apparatus will conduct a scanning by the terminal apparatus, searching for a wireless LAN base station by conducting the scanning, communicating with the wireless LAN base station by the terminal apparatus when the wireless LAN base station is found and repeating said communicating with a WIBRO or WiMAX base station when the wireless LAN base station is not found.

To achieve objects of embodiments of the application in whole or in part, there is provided a terminal apparatus including an antenna, an RF circuit coupled to the antenna, a WiBro or WIMAX baseband processor coupled to the RF circuit, a wireless LAN baseband processor coupled to the RF circuit, a resource scheduler to determine a selected baseband processor for use among the WiBro or WIMAX baseband processor and the wireless LAN baseband processor, and to control a frequency of a local oscillator of the RF circuit according to the selected baseband processor, wherein the resource scheduler is configured to control the WiBro or WIMAX baseband processor to inform the WiBro or WIMAX base station of intermittent scanning to conduct during a communication, and is configured to control the wireless LAN baseband processor to scan for search a wireless LAN base station.

Additional advantages, objects, and features of the invention will be set forth in part in the description which follows and in part will become apparent to those having ordinary skill in the art upon examination of the following or may be learned from practice of the invention. The objects and advantages of the invention may be realized and attained as particularly pointed out in the appended claims.

### BRIEF DESCRIPTION OF THE DRAWINGS

The embodiments will be described in detail with reference to the following drawings in which like reference numerals refer to like elements wherein:

FIG. 1 is a diagram showing a system in accordance with an embodiment of the application;

FIG. 2 is a flow chart showing a method in accordance with an embodiment of the application; and

FIG. 3 is a block diagram showing an example of a terminal apparatus shown in FIG. 1.

### DETAILED DESCRIPTION OF THE PREFERRED EMBODIMENTS

Embodiments according to the application will be described with reference to the accompanying drawings. Such embodiments are exemplary and not to be construed as limiting. Many alternatives, modifications, and variations will be apparent to those skilled in the art.

The wireless LAN conforming to 802.11g standards supports a maximum 54 Mbps transmission speed. Since the transmission speed of the wireless LAN is higher than that of the WiBro, a user of a wireless internet may prefer to use the wireless LAN rather to use the WiBro within an area where the wireless LAN service is available. Further, within the area where the wireless LAN service is available, a WiBro service provider may want to use the wireless LAN service without installing a WiBro base station to save the expense rendered in installing the WiBro base station. For at least such reasons, when a user moves to a wireless LAN service area, it is required to perform a handoff from the WiBro service to the wireless LAN service.

Although it is needed to conduct a handoff from the WiBro service to the wireless LAN service, there are not technologies related to the handoff between such a different kind of services in the WiBro standards and the wireless LAN standards. Thus, it is strongly required to develop a handoff method using both of a conventional WiBro protocol and a conventional wireless LAN protocol.

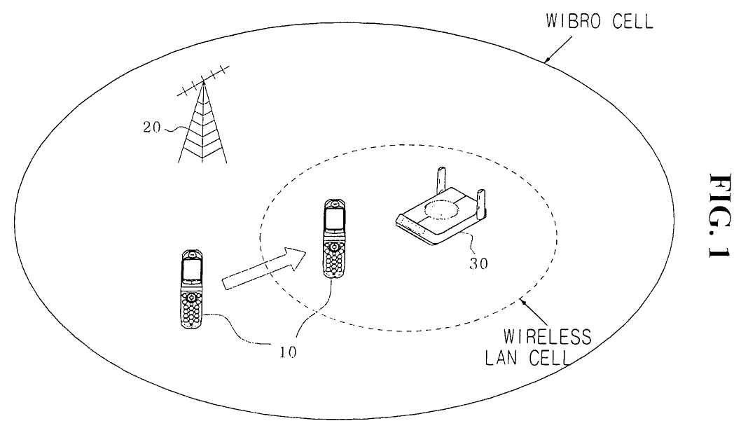

FIG. 1 is a diagram showing a system in accordance with an embodiment of the application. As shown in FIG. 1, the system can include a terminal apparatus 10, a WiBro base station 20 and a wireless LAN base station 30.

The terminal apparatus (e.g., terminal apparatus 10) is a portable apparatus capable of performing both of a communication according to a wireless LAN standard and a communication according to a WiBro standard, and may be, e.g., a notebook, a cellular phone, a PDA (personal digital assistant) or the like. However, embodiments of the application are not intended to be limited by such an exemplary disclosure. For example, in the wireless LAN standard, the terminal apparatus 10 is referred to as a station. Further, in the WiBro standard, the terminal apparatus 10 is referred to as a PPS (portable subscriber station).

The WiBro base station 20 can be referred to as a RAS (radio access station) and can communicate with the terminal apparatus 10 according to the WiBro standard. For example, the WiBro base station 20 can conduct a communication by using a frequency band of 2.3 GHz.

The wireless LAN base station 30 can be referred to as an AP (access point) and can communicate with the terminal apparatus 10 according to the wireless LAN standard. For example, the wireless LAN base station 30 can conduct a communication by using an unlicensed 2.4 GHz ISM (industrial, scientific and medical) frequency band.

As shown in FIG. 1, a handoff has to be performed when the terminal apparatus 10 located in a WiBro cell moves into a wireless LAN cell. For example, although a WiBro service is available within the wireless LAN cell, the terminal apparatus 10 can perform a handoff to a wireless LAN service to obtain a higher transmission speed. Further, if the WiBro service is not available within the wireless LAN cell, that is, if the inside of the wireless LAN cell is a shadow area in connection with the WiBro base station 20, the terminal apparatus 20 has to perform a handoff to the wireless LAN service to continuously receive an internet service.

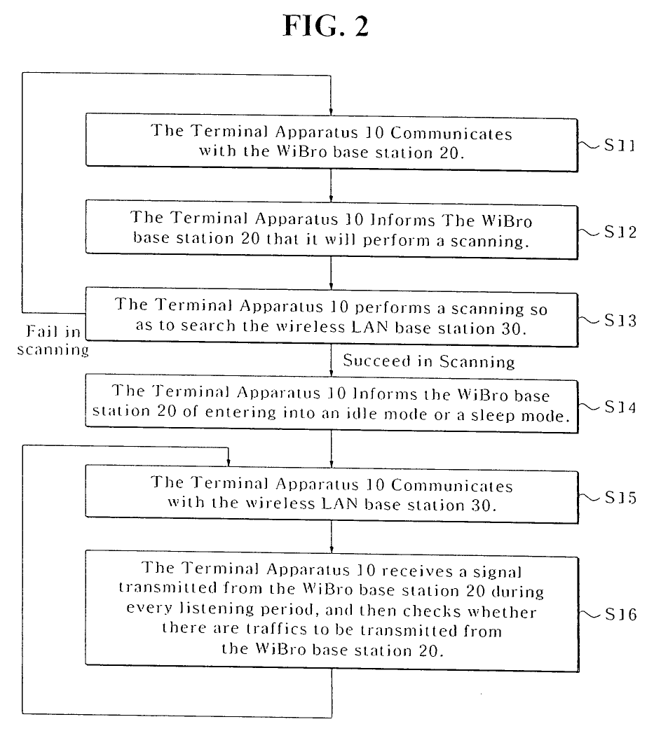

FIG. 2 is a flow chart showing a handoff method in accordance with an embodiment of the application. As shown in FIG. 2, the handoff method embodiment will be described using the embodiment of FIG. 1, however, the method embodiment of FIG. 2 is not intended to be limited thereby.

First, the terminal apparatus 10 can communicate with the WiBro base station 20 (block S11). Then, the terminal apparatus 10 can inform the WiBro base station 20 that it will perform a scanning (block S12).

For example, the terminal apparatus 10 transmits a scanning request message to the WiBro base station 20 to inform the WiBro base station 20 that the terminal apparatus 10 will perform a scanning. Although the scanning request message is usually used to measure a signal quality of an adjacent WiBro base station, the embodiment of FIG. 2 can use this message in order to measure a signal quality of the wireless LAN base station 30. The WiBro base station 20 preferably sends a scanning response message to the terminal apparatus 10 in response to the scanning request message. The scanning response message includes information on a period during which the terminal apparatus 10 can measure a signal quality of other base station, e.g., a period for use in a scanning.

Next, the terminal apparatus 10 can perform a scanning to search a wireless LAN base station 30 (block S13). In accordance with the wireless LAN standard, the scanning is preferably classified into a passive scanning and an active scanning. In case of the passive scanning, the wireless LAN base station 30 can broadcast a beacon signal periodically and then the terminal apparatus 10 can receive the beacon signal and determine whether it will connect to the wireless LAN base station 30 or not. In case of the active scanning, the terminal apparatus 10 can broadcast a probe frame and the wireless LAN base station 30 can send a probe response in response to the probe frame. Then, the terminal apparatus 10 determines whether or not it can/will connect with the wireless LAN base station 30 in response to the probe response.

Further, the terminal apparatus 10 can employ any one or both of the active scanning and the passive scanning in order to search the wireless LAN base station 30. If the terminal apparatus 10 fails to find the wireless LAN base station 30 as a result of the search, the terminal apparatus 10 can continue communicating with the WiBro base station 20 (block S11). If the terminal apparatus 10 finds the wireless LAN base station 30 as a result of the search, the terminal apparatus 10 can continue the handoff process.

Upon successful scanning, the terminal apparatus 10 can inform the WiBro base station 20 of a mode change, e.g., entering into an idle mode or a sleep mode (block S14). If the terminal apparatus 10 enters into the sleep mode, the terminal apparatus 10 transmits a sleep mode request to the WiBro base station 20 to inform the WiBro base station 20 of entrance into the sleep mode. Then, the terminal apparatus 10 receives a sleep mode response including information on a sleep mode entrance time, a sleep period and a listening period from the WiBro base station 20. If the terminal apparatus 10 enters into the idle mode, the terminal apparatus 10 transmits an idle mode request to the WiBro base station 20 in order to inform the WiBro base station 20 of entrance into the idle mode. Then, the terminal apparatus 10 receives an idle mode response including information on an idle mode entrance time, an idle period and a listening period from the WiBro base station 20. In addition, even after the terminal apparatus 10 changes mode (e.g., enters into the sleep mode or the idle mode), the terminal apparatus 10 can check whether there are traffics (e.g., data) to be transmitted from the WiBro base station by using the listening period. Then, the terminal apparatus 10 can communicate with the wireless LAN base station 30 (block S15).

The terminal apparatus 10 can receive a signal transmitted from the WiBro base station 20 during every listening period e.g., decided in the block S14, and then check whether there are traffics to be transmitted from the WiBro base station 20 (block S16). Specifically, the terminal apparatus 10 can receive a traffic indication message from the WiBro base station 20 during every listening period, where the traffic indication message informs the terminal apparatus 10 that there are traffics to be transmitted from the WiBro base station 20. If the traffic indication message indicates that there is no traffic to be transmitted, the terminal apparatus 10 can communicate with the wireless LAN base station again (block S15). If the traffic indication message indicates that there are traffics to be transmitted, the terminal apparatus 10 preferably receives the traffics from the WiBro base station 20 and then communicates with the wireless LAN base station 20 again (block S15).

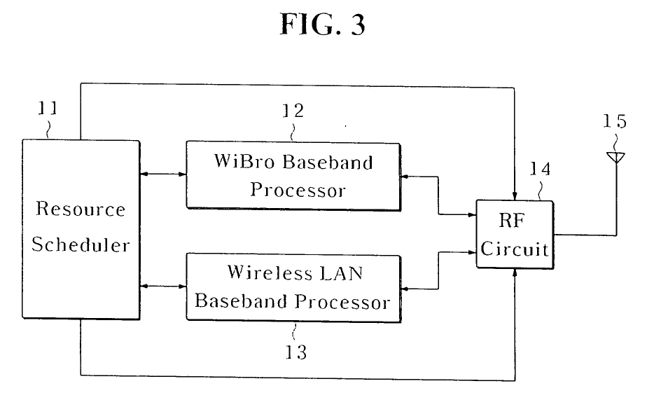

FIG. 3 provides a block diagram showing an example of the terminal apparatus. As shown in FIG. 3, the terminal apparatus can be used as the terminal apparatus 10 shown in FIG. 1. Referring to FIG. 3, the terminal apparatus can include a resource scheduler 11, a WiBro baseband processor 12, a wireless LAN baseband processor 13, an RF circuit 14 and an antenna 15.

Although two baseband processors 12 and 13 are included therein, the terminal apparatus may employ the single RF circuit 14 and antenna 15. However, embodiments of the application are not intended to be limited by such an exemplary disclosure. For example, two RF circuits being one each for the baseband processors 12, 13 or even two antennas may be provided. Since two baseband processors 12 and 13 use the single RF circuit 14 and antenna 15 in FIG. 3, both of communication with the WiBro base station 20 and a communication with the wireless LAN base station 30 can not be carried out at the same time. Since a frequency band of the WiBro is different from that of the wireless LAN, the RF circuit 14 has to change a frequency of a local oscillator according to which one of the WiBro baseband processor 12 and the wireless LAN baseband processor 13 is to be used.

The WiBro baseband processor 12 can communicate with the WiBro base station 20 via the RF circuit 14 and the antenna 15. The wireless LAN baseband processor 13 can communicate with the wireless LAN base station 30 via the RF circuit 14 and the antenna 15.

The resource scheduler 11 can determine which one of the WiBro baseband processor 12 and the wireless LAN baseband processor 13 will be used, and then control (e.g., change) a frequency of the local oscillator of the RF circuit 14 according to which one of the WiBro baseband processor 12 and the wireless LAN baseband processor 13 will be used.

Moreover, the resource scheduler 11 can control the WiBro baseband processor 12, the wireless LAN baseband processor 13 and the RF circuit 14 to perform each portion of a WiBro communication, a wireless LAN communication or the method embodiment shown in FIG. 2. For example, the resource scheduler 11 controls the WiBro baseband processor 12 to inform the WiBro base station 20 that it will perform a scanning occasionally while performing a communication, and controls the wireless LAN baseband processor 13 to perform a scanning for searching the wireless LAN base station 30. If the wireless LAN base station 30 is found as a result of the scanning, the resource scheduler 11 can control the wireless LAN baseband processor 13 to communicate with the wireless LAN base station 30. Before the wireless LAN baseband processor 13 communicates with the wireless LAN base station 30, the resource scheduler 11 may control the WiBro baseband processor 12 to inform the WiBro base station 20 of the entrance into the idle or the sleep mode. While the wireless LAN baseband processor 13 is communicating with the wireless LAN base station 30, the resource scheduler 11 can control the WiBro baseband processor 12 to receive the occassional signal transmitted from the WiBro base station 20, to thereby check whether there are traffics to be transmitted from the WiBro base station 20. If there are traffics to be transmitted as a result of the check, the resource scheduler 11 controls the wireless LAN baseband processor 13 to communicate with the wireless LAN base station 30 after the WiBro baseband processor 12 receives the traffics to be transmitted from the WiBro base station 20. If there's no traffic to be transmitted as a result of the check, the resource scheduler 11 can control the wireless LAN baseband processor 13 to communicate with the wireless LAN base station 30.

One handoff method embodiment can perform a communication with a WiBro or WIMAX base station by a terminal apparatus, inform the WiBro or WIMAX base station that the terminal apparatus will search for wireless LAN communication capability, search for the wireless LAN communication capability, communicate with the wireless LAN communication capability or repeat the communication with the WIBRO or WIMAX base station when the wireless LAN communication capability is not found.

As described above, embodiments of methods and systems for performing a handoff from the WiBro (e.g., WIMAX service to the wireless LAN service and a terminal apparatus using the same have various advantages. For example, embodiments in accordance with the application are advantageous in that they can perform a handoff from the WiBro service to the wireless LAN service.

Further, embodiments in accordance with the application are also advantageous because they provide a user with a service supporting a higher transmission speed by performing a handoff to the wireless LAN service upon entering into an area where the wireless LAN service is available. In addition, one embodiment of a method and system for performing a handoff from the WiBro (WIMAN service to the wireless LAN service and a terminal apparatus in accordance with the application is advantageous because a wireless LAN baseband processor can share an RF circuit and an antenna with a WiBro baseband processor to use (e.g., conduct a handoff) a terminal apparatus manufactured at a low cost.

Furthermore, embodiments in accordance with the application are also advantageous in that the terminal apparatus performs a handoff to the wireless LAN service after informing the WiBro base station of a mode change (e.g., entering into the idle or the sleep mode), so that the terminal apparatus can receive information supplied to the WiBro base station after the handoff operation without a miss and can rapidly (e.g., immediately) return to the WiBro service.

Any reference in this specification to “one embodiment,” “an embodiment,” “example embodiment,” etc., means that a particular feature, structure, or characteristic described in connection with the embodiment is included in at least one embodiment of the invention. The appearances of such phrases in various places in the specification are not necessarily all referring to the same embodiment. Further, when a particular feature, structure, or characteristic is described in connection with any embodiment, it is submitted that it is within the purview of one skilled in the art to affect such feature, structure, or characteristic in connection with other ones of the embodiments. Furthermore, for ease of understanding, certain method procedures may have been delineated as separate procedures; however, these separately delineated procedures should not be construed as necessarily order dependent in their performance. That is, some procedures may be able to be performed in an alternative ordering, simultaneously, etc.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A handoff method, comprising:
(a) communicating with a WiBro or WIMAX base station by a terminal apparatus;
(b) informing the WiBro or WIMAX base station that the terminal apparatus will conduct a scanning by the terminal apparatus;
(c) searching for a wireless LAN base station by conducting the scanning;
(d) communicating with the wireless LAN base station by the terminal apparatus when the wireless LAN base station is found; and
(e) repeating said communicating with a WIBRO or WiMAX base station when the wireless LAN base station is not found.

2. The handoff method of claim 1, wherein said informing the WiBro or WIMAX base station that the terminal apparatus will conduct a scanning comprises:
(b1) transmitting a scanning request message to the WiBro or WIMAX base station to inform the WiBro or WIMAX base station that the terminal apparatus will perform the scanning; and
(b2) receiving a scanning response message for informing the terminal apparatus of a period when the terminal apparatus can perform the scanning.

3. The handoff method of claim 1, comprising:
(f) informing the WiBro or WIMAX base station that t he terminal apparatus is entering into an idle mode or a sleep mode before said communicating with the wireless LAN base station by the terminal apparatus.

4. The handoff method of claim 1, comprising:
transmitting a sleep mode request to the WiBro or WIMAX base station to inform the WiBro or WIMAX base station of entrance into the sleep mode by the terminal apparatus; and
receiving a sleep mode response by the terminal apparatus including information on a sleep mode entrance time, a sleep period and a listening period from the WiBro or WIMAX base station.

5. The handoff method of claim 1, comprising:
transmitting an idle mode request to the WiBro or WIMAX base station to inform the WiBro or WIMAX base station of entrance into the idle mode; and
receiving an idle mode response by the terminal apparatus including information on an idle mode entrance time, an idle period and a listening period.

6. The handoff method of claim 5, comprising:
receiving a signal transmitted from the WiBro or WIMAX base station during the listening period and checking whether there are traffics to be transmitted from the WiBro or WIMAX base station by the terminal apparatus.

7. The handoff method of claim 6, comprising:
receiving a traffic indication message from the WiBro or WIMAX base station during at least one listening period, wherein the traffic indication message informs the terminal apparatus that there are traffics to be transmitted from the WiBro or WIMAX base station; and
returning to communicating with the WiBro or WIMAX base station to receive said traffics.

8. The handoff method of claim 6, comprising:
receiving a traffic indication message from the WiBro or WIMAX base station during at least one listening period, wherein the traffic indication message designates no traffic to be transmitted; and
returning to said communicating with the wireless LAN base station by the terminal apparatus.

9. A terminal apparatus, comprising:
an antenna;
an RF circuit coupled to the antenna;
a WiBro or WIMAX baseband processor coupled to the RF circuit;
a wireless LAN baseband processor coupled to the RF circuit;
a resource scheduler to determine a selected baseband processor for use among the WiBro or WIMAX baseband processor and the wireless LAN baseband processor, and to control a frequency of a local oscillator of the RF circuit according to the selected baseband processor,
wherein the resource scheduler is configured to control the WiBro or WIMAX baseband processor to inform the WiBro or WIMAX base station of intermittent scanning to conduct during a communication, and is configured to control the wireless LAN baseband processor to scan for search a wireless LAN base station.

10. The terminal apparatus of claim 9, wherein the resource scheduler is configured to control the wireless LAN baseband processor to communicate with the wireless LAN base station when the wireless LAN base station is found as a result of the scan.

11. The terminal apparatus of claim 9, wherein the resource scheduler is configured to control the WiBro or WIMAX baseband processor to communicate with the WiBro or WIMAX base station when the wireless LAN base station is not found as a result of the scan.

12. The terminal apparatus of claim 11, wherein the WiBro or WIMAX baseband processor transmits a sleep mode request to the WiBro or WIMAX base station to inform the WiBro or WIMAX base station of entrance into the sleep mode by the terminal apparatus and receives a sleep mode response including information on a sleep mode entrance time, a sleep period and a listening period from the WiBro or WIMAX base station.

13. The terminal apparatus of claim 11, wherein the WiBro or WIMAX baseband processor transmits an idle mode request to the WiBro or WIMAX base station to inform the WiBro or WIMAX base station of entrance into the idle mode and receives an idle mode response by the terminal apparatus including information on an idle mode entrance time, and idle period and a listening period.

14. The terminal apparatus of claim 11, wherein during the wireless LAN baseband processor communication with the wireless LAN base station, the resource scheduler controls the WiBro or WIMAX baseband processor to receive a scheduled signal from the WiBro or WIMAX base station, to check for data to be transmitted from the WiBro or WIMAX base station.

15. The terminal apparatus of claim 14, wherein, when there exists data to be transmitted as a result of the check, the resource scheduler controls the WiBro or WIMAX baseband processor to receive the data to be transmitted from the WiBro or WIMAX base station and then controls the wireless LAN baseband processor to communicate with the wireless LAN base station.

16. The terminal apparatus of claim 10, wherein the resource scheduler is configured to control the WiBro or WIMAX baseband processor to inform the WiBro or WIMAX base station of entrance into the idle or the sleep mode before the wireless LAN baseband processor communication with the wireless LAN base station.
